(19) United States
(12) Patent Application Publication
(10) Pub. No.: US 2007/0078191 A1
(43) Pub. Date: Apr. 5, 2007

(54) Foamed reinforced composite siding product

(76) Inventors: Brian J. Guhde, Westerville, OH (US); Donn R. Vermilion, Newark, OH (US); George A. Walrath, Newark, OH (US); Christine M. Watson, Heath, OH (US)

Correspondence Address: OWENS CORNING, 2790 COLUMBUS ROAD, GRANVILLE, OH, 43023, US

(21) Appl. No.: 11/241,442

(22) Filed: Sep. 30, 2005

(51) Int. Cl. C08J 9/00

(52) U.S. Cl. 521/99

(57) ABSTRACT

A composition for forming a reinforced composite siding product and a composite siding product formed by an extrusion process utilizing the composition is provided. The mixed resin formulation utilized to form the composite siding product includes a polymeric resin, a filler, a processing aid, at least one lubricant, and a thermal stabilizer. In a preferred embodiment, the polymer resin is polyvinyl chloride and the filler is talc. The mixed resin formulation may be extruded with a reinforcement material in a screw extrusion process to form a composite siding product. One or more reinforcing fibers may be utilized in the extrusion process. The reinforcement fibers may be present in the final product in an amount up to 25% by weight of the final product. In at least one preferred embodiment, the reinforcement fibers are glass fibers. A weatherable cap may be co-extruded to form the final reinforced, foamed composite siding product.

### TECHNICAL FIELD AND INDUSTRIAL

1. Applicability of the Invention

The present invention relates generally to siding products, and more particularly, to a foamed, reinforced composite siding product.

2. Background of the Invention

External siding products have been used for years as exterior surface coverings on buildings such as residential homes to give the buildings aesthetically pleasing appearances. For example, external siding formed of wood, brick, stone, stucco, cement, and vinyl (such as polyvinyl chloride (PVC)) are well-known. Vinyl siding has the advantage of being able to be formed into a variety of shapes and colors by known extrusion and molding processes. In addition, vinyl siding may be easily cleaned, is low maintenance, is inexpensive, and can be installed quickly and easily on new construction or remodeling jobs without breaking. Vinyl siding, brick, stone, stucco, and cement siding are all resistant to physical deterioration (e.g., rotting) and insect attack. Further, these materials do not support combustion, and therefore, may act as a fire retardant.

Despite the advantages associated with conventional siding products, there are some disadvantages associated with these products. For example, vinyl siding may be subject to heat distortion at extreme temperatures which may cause the siding to warp or distend. Such distortions or bulges in the siding creates an unsightly appearance for the home. A further problem with conventional vinyl siding materials is that the vertical edges of adjacent vinyl siding panels may not lay flat as a result of a deformation of the shape of the vinyl siding due to improper manufacturing, handling, and/or installation. In addition, unequal pressure on the siding, such as may be caused by improper nailing of the siding to the house, may cause the siding to buckle or bend. Further, due to the light weight of the vinyl siding, the siding panels may rattle during storms when wind gets behind the siding panels. Additionally, over time, the thin wall thickness of the vinyl siding may cause the siding to become brittle due to the effects of various environmental factors.

In addition, brick, stucco, wood, and cement siding require periodic maintenance and cleaning. For example, over time, wood siding, cement siding, and stucco may have be painted and re-caulked due to exposure to the elements or replaced due to rotting or insect invasion. Brick has to be periodically cleaned and re-cemented in places to maintain an optimal physical appearance. Cement siding products are typically brittle and may easily break during installation. In addition, stucco, wood, and cement siding are highly sensitive to moisture, which can cause physical decay of the siding product if not properly protected and maintained. Further, water contamination may provide a support medium for the growth of bacteria, fungi, and/or mold which may cause unpleasant odors and a discoloration in the siding product.

Attempts have been made to make improved siding products that address the negative aspects of conventional siding such as described above. Some examples of these siding products are described below.

U.S. Pat. Nos. 6,122,877 and 6,682,814 to Hendrickson et al. describe a siding or trim unit that is manufactured from a composite material composed of cellulosic fibers (e.g., wood fibers) and thermoplastic polymer materials (e.g., polyvinyl chloride). The composite material may be formed of 35-60 parts of fiber and 45-70 parts of polymer per 100 parts of the composite material.

U.S. Pat. No. 6,344,268 and U.S. Patent Application Publication No. 2004/0170818 to Stucky et al. disclose foamed polymer-fiber composites used in the fabrication of decking, railing, siding, and structural materials. The composite material includes 35-75 wt. % of the polymeric resin and about 25-65 wt. % fiber. The fiber may be glass, wood, cotton, boron, carbon, or graphite fibers. It is preferred that the fibers are cellulosic in nature. The polymer-fiber composite has a specific gravity of less than about 1.25 g/cc. It is asserted that the products are lightweight and provide adequate strength and mechanical properties for building requirements.

U.S. Pat. No. 6,030,447 to Naji et al. disclose a formulation for preparing a material that includes a cementitious material (e.g., Portland cement) in an amount from 10-80 wt %, a siliceous material (e.g., ground sand) in an amount from 10-80 wt %, and a dehydroxylated clay mineral. It is asserted that autoclave-cured cementitious materials are commonly used both with and without reinforcement fibers to manufacture many building products.

U.S. Patent Application Publication No. 2004/0048055 to Branca describe a pultrusion process where continuous fibers (e.g., glass, carbon, aramid, steel or other high stiffness fibers) are pulled through a die in which the fibers are impregnated with a resin and the resin-fiber combination is shaped into a profile that can be used to manufacture the continuous fiber composite profiles to any suitable cross-sectional shape. It is asserted that the composite reinforced synthetic product may be used to form a siding product.

U.S. Patent Application Publication No. 2004/0009338 to Jo et al. disclose polymeric building materials that include a composite reinforcement having continuous filaments of fibers substantially oriented in at least a first direction within a polymeric matrix. In a preferred embodiment, the fiber content in the composite is from 20%-80% and includes glass fibers, carbon fibers, and/or aramid fibers. The composite material may be used as a roofing shingle or siding member.

Despite the attempts to form an improved siding product, there still exists a need in the art for a siding product that is lightweight, flexible, easy to install, durable, is moisture, freeze, and thaw resistant, has improved resistance to thermal distortion, and has improved crack and puncture resistance.

### SUMMARY OF THE INVENTION

It is an object of the present invention to provide a reinforced, foamed siding product formed from a composition that includes a polymeric resin, a filler, a processing aid, a lubricant, and a stabilizer. The polymeric resin may have a weight average molecular weight from about 50,000-100,000 g/mole. Preferably, the polymer resin is polyvinyl chloride. Although any polyvinyl chloride may be utilized, it is even more preferred that the polyvinyl chloride has a K-value of from 54-60. Suitable fillers that may be used in the composition include calcium carbonate, talc, aluminum trihydrate, clays, calcium silicate, graphite, kaolin, magnesium oxide, molybdenum disulfide, silica, slate powder, zinc salts, zeolites, calcium sulfate, barium salts, Portland cement, perlite, diatomaceous earth, mica, wollastonite, ground scrap glass fibers, flaked glass, nano-particles, and/or mineral wool. Preferably, the filler has an aspect ratio of 5-50. The reinforced, foamed siding product may have a glass content up to 25% by weight of the siding product. The use of synthetic fibers alone or in conjunction with the glass fibers is considered to be within the purview of the invention.

It is also an object of the present invention to provide a mixed resin composition for forming a reinforced, foamed siding product that includes a polymeric resin, a filler, a processing aid, one or more lubricants, and a thermal stabilizer. The polymeric resin provides strength, flexibility, toughness and durability to the siding product. The polymeric resin is not particularly limited, but is preferably polyvinyl chloride, and even more preferably, a polyvinyl chloride with a K-value of from 54-60. The polymeric resin(s) may be present in the composition from about 60 to about 85% by weight of the active solids in the composition. The filler is added to increase the modulus or stifffiess of the siding product and may decrease the amount of movement that can occur as a result of a change of temperature in the siding product. Examples of suitable fillers that may be used in the composition include calcium carbonate, talc, aluminum trihydrate, and mineral wool. Preferably, the filler has an aspect ratio of from 5-50. The filler may be present in an amount up to about 40% by weight of the active solids in the composition. Any suitable processing aid, lubricant, and thermal stabilizer may be used. The processing aid(s) may be present in the composition from about 5 to about 20% by weight of the active solids in the composition, the lubricant(s) may be present in an amount of about 0.5 to about 5% by weight of the active solids in the composition, and the thermal stabilizer may be present in an amount from about 0.5 to about 2.0% by weight of the active solids in the composition. The composition may be utilized with reinforcement fibers and a blowing agent in an extrusion process to form a reinforced, foamed siding product.

It is a further object of the present invention to provide a method of making a reinforced, foamed siding product. The mixed resin formulation described in detail above may be mixed with glass fibers, a foaming agent, and any desired colorants and fed into an extruder. The polymeric resin in the resin formulation is melted by the mechanical action of the screw within the barrel of the extruder and/or by heaters attached to the extruder and mixed with the glass fibers into a substantially homogenous mixture. The resin/glass fiber mixture is conveyed from the extruder as an extrudate into a shaping die which is designed to shape the extrudate into a desired shape and to create a pressure drop which permits the extrudate to develop a foamed cell structure. As the extrudate exits the shaping die and enters a zone of reduced pressure, it begins to foam. The foaming extrudate may be pulled into a calibrator by a pulling apparatus. The desired shape of the foamed, reinforced siding product is formed in the die and is maintained in that shape in the calibrator until the polymeric melt is cool enough to hold the shape. Optionally, the extrudate is pulled through a second calibrator. Next, the extrudate may be passed through at least one cooling tank to cool the extrudate and further set it into the predetermined, desired shape. The cooled and set extrudate may then be passed through an embosser which places a design, such as wood grain, on the extrudate so that the final product formed has an aesthetically pleasing surface. The extrudate may then pass through a cut-off/trimming apparatus where the extrudate may be cut into discrete lengths. The formed, reinforced siding product may then be passed through a perforator which punches or drills holes (voids) in the extruded material to serve as nailing slots. The final product may be stacked on a packing table for packaging and subsequent shipping.

A cap may be co-extruded with the foamed, reinforced product by positioning a cap extruder on the extrusion line. A cap stock and optionally color pellets may be fed into the cap extruder. The molten cap stock mixture that exits the cap extruder is conveyed to the extrusion die. To co-extrude a cap, the cap formed from the cap stock and the extrudate formed from the polymeric resin/fiber mixture from the extruder exit the die at substantially the same time. The cap may have a thickness from approximately 0.002-0.02 inches. The cap forms a weather barrier to help protect the siding product from harmful effects caused by environmental factors such as sun, rain, and wind. Suitable weatherable cap materials include acrylic resins based upon methyl methacrylate, poly(butylacrylate-styrene-acrylonitrile), polyvinylidene fluoride, polyvinylfloride, and SAN, a copolymer of styrene and acrylonitrile.

It is an advantage of the present invention that the foamed nature of the siding product allows for a cladding product to be manufactured at a weight that it is easy to install yet is strong enough to withstand substantial windloads.

It is another advantage of the present invention that the closed cell foam structure keeps water and moisture out of the siding product, thereby reducing or even eliminating freeze/thaw effects that damage conventional exterior cladding products.

It is a further advantage of the present invention that the closed cell foam structure keeps water and moisture out of the siding product, thereby reducing or even eliminating freeze/thaw effects that damage conventional exterior cladding products.

It is yet another advantage of the present invention that the reinforced, foamed siding product does not require painting and/or caulking to prevent moisture and freeze/thaw damage.

It is a further advantage of the present invention that the siding product does not suffer the handling damage observed with conventional wood and cement siding products.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of an extruder apparatus for extruding a foamed composite siding product according to one exemplary embodiment of the present invention;

FIG. 2 is a schematic illustration of an extruder apparatus for extruding a foamed composite siding product according to another exemplary embodiment of the present invention;

FIG. 3 is a schematic illustration of an extrusion line according to one aspect of the present invention; and

FIG. 4 is a schematic illustration of an extrusion line for co-extruding a cap stock according to at least other exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. It will be understood that when an element is referred to as being “on,”another element, it can be directly on or against the other element or intervening elements may be present. The terms “foaming agent” and “blowing agent” may be used interchangeably herein. In addition, the term “composition” and “formulation” may be used interchangeably herein. Further, the terms “cladding” and “siding” may be interchangeably used.

The present invention relates to a composition for forming a composite siding product and a composite siding product formed by an extrusion or co-extrusion process utilizing the composition. The composition utilized to form the composite siding product includes a polymeric resin, a filler, a processing aid, a lubricant, a stabilizer, and optionally other additives and/or reinforcements.

The polymeric resin is the backbone of the formulation and provides strength, flexibility, toughness and durability to the final product. The polymeric resin may be in the form of a flake, granule, pellet, and/or powder. The polymeric resin is not particularly limited, and suitable polymeric resins may include, but are not limited to, polyvinyl chloride (PVC), chlorinated polyvinyl chloride (CPVC), polyethylene, polypropylene, polycarbonates, polystyrene, styreneacrylonitrile, acrylonitrile butadiene styrene, acrylic/styrene/acrylonitrile block terpolymer (ASA), polysulfone, polyurethane, polyphenylenesulfide, acetal resins, polyamides, polyaramides, polyimides, polyesters, polyester elastomers, acrylic acid esters, copolymers of ethylene and propylene, copolymers of styrene and butadiene, copolymers of vinylacetate and ethylene, and combinations thereof. In addition, the polymeric resin may be post industrial or consumer grade (e.g., regrind). The composition may include one or more polymeric resin. Preferably, the polymeric resin has a weight average molecular weight from about 50,000-100,000 g/mole. In a preferred embodiment, the polymer resin is polyvinyl chloride. Although any polyvinyl chloride may be utilized, it is even more preferred that the polyvinyl chloride has a K-value of from 54-60 (e.g., a weight average molecular weight of from approximately 70,000-100,000 g/mole). The K-value of a polymeric resin is a measure of the molecular weight of the resin based on its inherent viscosity. The lower molecular weight of the polymer resin permits the resin to foam and process more easily than higher molecular weight polymer resins, e.g., resins with a higher K-value. The polymeric resin(s) may be present in the composition from about 60 to about 85% by weight of the active solids in the composition, preferably from about 70 to about 80% by weight of the active solids.

Fillers are added to increase the modulus or stiffness of the composite siding product and may decrease the amount of movement that can occur as a result of a change of temperature of the siding product. Examples of suitable fillers that may be used in the composition include calcium carbonate, talc, aluminum trihydrate, clays, calcium silicate, graphite, kaolin, magnesium oxide, molybdenum disulfide, silica, slate powder, zinc salts, zeolites, calcium sulfate, barium salts, Portland cement, perlite, diatomaceous earth, mica, wollastonite, ground scrap glass fibers, flaked glass, nano-particles (e.g., nano-clays, nano-talcs, and nano-TiO₂), and/or mineral wool. The filler may be present in the composition from about 0 to about 40% by weight of the active solids in the composition, preferably from 15-40% by weight of the active solids in the composition, and more preferably from about 20 to about 32% by weight of the active solids in the composition.

In preferred embodiments, the filler has an aspect ratio from about 5-50, and even more preferably from 20-50. A filler having an aspect ratio greater than 20, such as talc, may significantly reduce the amount of expansion and contraction in the machine direction of the board by reducing the coefficient of thermal expansion (CTE) of the foamed, reinforced siding product in the direction of the long axis of the filler, especially if the fillers are well-aligned in the machine direction of the extruded product. Fibers are even more effective than fillers with high aspect ratios since they typically have even higher aspect ratios and more uniform dimensions. In addition, many synthetic commercially available fibers are manufactured to include surface treatments to enhance resin wetting and bonding. Further, introducing higher aspect ratio fillers increases the ability to transfer the transverse load to the filler in the direction of the long axis. Additionally, adding a filler may reduce the CTE of the foamed, reinforced siding composite proportionately by the volume fraction of the filler and their relative CTEs. Aligning the long axis and increasing the aspect ratio may greatly increase the effect of the filler/fiber in the direction of the orientation and increase the mechanical properties of the composite, including CTE.

As discussed above, the composition also contains a processing aid. Processing aids help the processing of the polymeric resin by promoting fusion, improving melt strength, eliminating surface defects and decreasing plate out. In addition, the processing aids enhance formulation metal release properties in extrusion and calendaring applications Preferably, the processing aid is an acrylic processing aid such as, but not limited to poly(methyl methacrylate) commercially available under the trade names Paraloid K-400, Paraloid K-128N, and Paraloid K-125 from Rohm & Haas. Additional processing aids commercially available from Rohm & Haas include Paraloid K-120, Paraloid K-120N, Paraloid 120ND, Paraloid K-130D, Paraloid K-175, and Paraloid K-415. Other suitable processing aids include PA-20, PA-40, and PA-50 from Kaneka Corporation and Arkema's Plastistrength® processing aids 530, 550, 551, 710, 770, and L1000. Further examples of suitable processing aids for use in the inventive composition include chlorinated polyethylene, partially oxidized waxes, aliphatic polyolefins, and/or other high molecular weight resins that would aid in shear heating (e.g., polycarbonate or polyphenyleneoxide). The processing aid(s) may be present in the composition from about 5 to about 20% by weight of the active solids in the composition, preferably from about 8 to about 12% by weight of the active solids.

In addition, the composition contains at least one lubricant to facilitate manufacturing, e.g., the movement of the resin through the extruder. The lubricant may be present in the formulation in an amount of from about 0.5 to about 5% by weight of the active solids in the composition. Preferably, the lubricant is present in an amount of from about 1.5 to about 2.8% by weight of the active solids. Although any suitable lubricant may be used, specific examples of lubricants suitable for use in the size composition include amide waxes such as ethylene bis strearamide (e.g., Adva Wax 280, sold commercially by Rohm & Haas), oxidized polyethylene waxes (e.g., A-C® 629 A commercially available from Honeywell), polyethylene waxes (e.g., A-C® 6A commercially available from Honeywell), hydrocarbon waxes (e.g., paraffin waxes), carboxylic acid salts (e.g., calcium stearate), polypropylene waxes, and fatty acid ester waxes (e.g., distearyl phthalate).

The formulation also contains a thermal stabilizer. When polyvinyl chloride is the resin, the stabilizer aids in the retardation of the dehydrochlorination of the PVC and prevent burning of the PVC during the processing in the extruder. Stabilizers suitable for use in the present invention include organotin mercaptans, thioglycolates, reverse esters, and mixed metals based upon calcium and zinc. Such metal stabilizers are commercially available from Rohm and Haas under the trade names Advastab™ TM-181, Advastab™ TM-1830, Advastab™ TM-186, Advastab™ TM-440, Advastab™ S-1000, Advastab™ S-1201, Advastab™ S-1401, Advastab™ TM-182, Advastab™ TM-183C, Advastab™ TM-281, Advastab™ TM 283TM, Advastab™ TM-286SP, Advastab™ TM-599, Advastab™ TM-694, Advastab™ TM-697, Advastab™ TM-900, and Advastab™ TM-950. The stabilizer may be present in the composition from about 0.5 to about 2.0% by weight of the active solids in the composition, preferably from about 0.5 to about 0.8% by weight of the active solids. It is to be noted that lead-based stabilizers would be functional and could be used as a thermal stabilizer; however, they are toxic and may cause harmful effects to anyone who come into contact with such lead-based stabilizers (e.g., in the siding product).

Additives such as UV stabilizers (e.g., 2-(2′-hyrdroxyphenyl)benzotrazoles, 2-hydroxybenzophenones, cyanocrylates, oxanilides, and arylesters), biocides (e.g., 10-10′oxybisphenoxarsine, N-trichloromethylmercaptophthalimide, 2-n-octyl-4-isothiazoline-3-one, N-tricholomethylmercaptotetrahydrophthalimide), compatibilizers, melt strength enhancers, and/or tackifiers may be added to the resin. Preferably, the additives are present in the composition in an amount not to exceed 10% by weight of the active solids in the composition.

To form a mixed resin formulation that may be added to an extruder to form a composite product according to the present invention, the resin and stabilizer are added to a high intensity mixer and blended at high speed until the mixture reaches 150° F.±5° F. The lubricants and processing aid(s) (and any desired thermally stable additives) are then added to the blender and blended at high speed until the temperature of the mixture reaches 170° F.±5° F. At this time, the filler is added and high speed blending is continued until the temperature of the mixture reaches 210-215° F.±5° F. The heated mixture is then transferred to a cooling mixer (e.g., a low intensity mixture) where it is blended at low speed until the temperature reaches approximately 150° F. or below. Non-thermally stable additives may be added to the cooling mixer.

The mixed resin formulation is removed from the cooling mixer and conveyed to a suitable holding container for transferring to an extruder for immediate use or for storage for use at a later time. The mixed resin formulation may be extruded with a reinforcement material in a screw extrusion process to form a composite siding product. The reinforcing material may be any type of organic, inorganic, or natural fiber or other reinforcement material suitable for providing good structural qualities and durability. Examples of suitable reinforcement fibers and/or materials for use in the present invention include any type of glass fiber (e.g., A-type glass fibers, C-type glass fibers, E-type glass fibers, S-type glass fibers, AR type glass fibers, AF-type glass fibers, or modifications thereof), processed mineral fibers (PMF fibers) carbon fibers, natural fibers, synthetic fibers, mineral fibers, ceramic fibers, and milled fibers. The reinforcing fiber may be chopped fibers, long fibers, or continuous strand fibers. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, and henequen. One or more reinforcing fibers or reinforcing materials may be utilized in the extrusion process to form the final extruded product. In at least one preferred embodiment, the reinforcement fibers are dry chopped glass fibers.

The reinforcement fibers may be present in the final product in an from about 0-about 30% by weight of the final product, preferably from about 0-about 25% by weight of the final product, more preferably in an amount of from about 5-about 25% by weight of the final product, even more preferably in an amount up to 15% by weight of the final product, and most preferably from approximately 10-15% by weight of the final product. Although fiber lengths of any convenient size for processing in an extruder may be used, the reinforcing fibers preferably have diameters ranging from approximately 7-30 microns and lengths from approximately 2-25 mm. In more preferred embodiments, the reinforcing fibers have diameters of from 10-17 microns and lengths of from 4-6 mm.

The use of synthetic fibers such as polyester, polyethylene terephthalate, polypropylene, polyparaphenylene terephthalamide (sold commercially as Kevlar®), polyamide, aramid, polyimide, rayon, polyurethane and/or nylon fibers alone or in conjunction with the reinforcement fibers/materials described above is considered to be within the purview of the invention. The term “synthetic fibers” as used herein is meant to indicate any man-made fiber having suitable reinforcing characteristics.

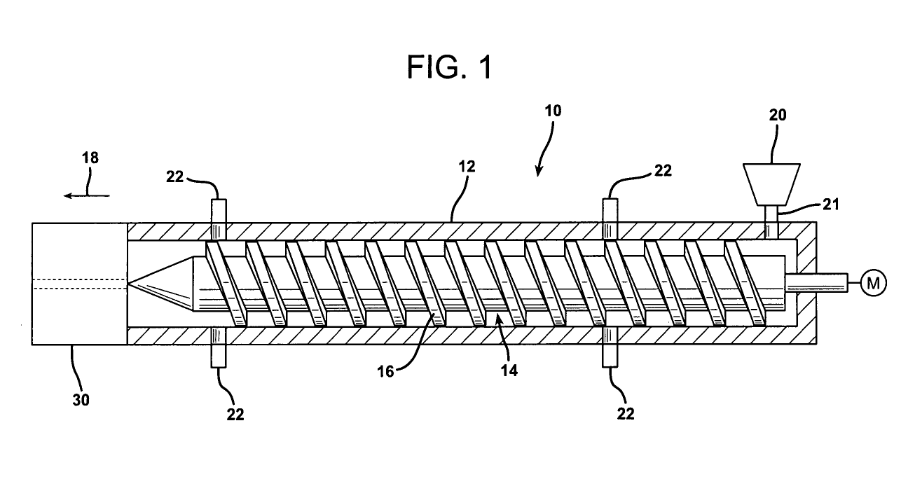

A screw extruder for use in the present invention is generally indicated at reference numeral 10 in FIG. 1. The screw extruder for use in the instant invention may equally be a single screw or twin screw extruder, reference is made herein with respect to a single screw extruder. The extruder 10 is formed of a barrel 12 and at least one screw 14 that extends substantially along the length of the barrel 12. A motor (M) may be used to power the screw 14. The screw 14 contains helical flights 16 rotating in the direction of arrow 18.

In operation, the mixed resin formulation described in detail above may be mixed with a reinforcement fiber such as dry chopped strand glass together with a foaming agent and any desired colorants in a hopper 20 and fed to the extruder 10 via a feedthroat 21. In this manner, the resin and the reinforcement fibers are substantially simultaneously fed into the barrel 12 of the extruder 10 through the resin/fiber hopper 20. As used herein, the term “substantially simultaneously fed” is meant to indicate that the resin and reinforcement fibers are fed into the barrel 12 at the same time or at nearly the same time. If the resin is in the form of a powder or flake, the resin may be metered into the barrel 12 by a metering apparatus, such as an auger or crammer (not shown), to force the resin into the barrel 12 against the rotating action of the screw 14. It is to be noted that one or more than one of the reinforcement fibers, reinforcement materials, and/or synthetic fibers could be added with the foaming agent and optional colorant. However, for ease of discussion, the apparatuses and processes depicted in FIGS. 1-4 will be described with reference to a reinforcement fiber. It is also to be noted that it is conceivable that color pellets may be fed into the extruder 10 from a color pellet hopper (not shown) to give the final product a desired color or appearance rather than, or in addition to, adding a colorant to through the resin/fiber hopper. In addition, a purchased or product regrind may optionally be added to the barrel 12 via feedthroat 21 with the resinous fiber mixture in an amount up to 25% by weight of the active solids in the composition, preferably in an amount from 5-10% by weight of the active solids in the composition.

The flights 16 of the screw 14 cooperate with the cylindrical inner surface of the barrel 12 to define a passage for the advancement of the resin and reinforcement fibers through the barrel 12. Mechanical action and friction generated by the screw 14 (with the assistance of external heaters 22) melt the polymeric resin in the resin formulation and mix and/or compound the resin and fibers into a substantially homogenous mixture. The heat from the barrel 12 and internal friction from the screw 14 causes the blowing agent to at least partially decompose. Heaters 22 may be placed on the barrel 12 at any location to facilitate the melting of the polymeric resin and decomposition of the foaming agent.

The resin/reinforcement fiber mixture is conveyed from the extruder 10 as an extrudate into a shaping die 30 which is designed to shape the extrudate into a desired shape and to create a pressure drop which permits the extrudate to develop a foamed cell structure. A breaker plate, screen or adapter (not shown) may be used to transition the extrudate from the extruder 10 to the shaping die 30. In the adapter, the extrudate is collected as it exits the extruder 10 and is re-shaped so that it may be fed into the die 30 as a solid and continuous slug. The shaping die 30 may be of any shape, such as, for example, a rectangle, sheet, or square. Alternatively, the shaping die 30 may be uniquely or irregularly shaped for a specific purpose. For example, the shaping die 30 may also be configured for use as a window or door profile or as a siding product. In addition, it is within the purview of this invention to include one or more dies 30 arranged in series to achieve the desired shape.

Typical chemical blowing (foaming) agents (e.g., materials that undergo decomposition reactions producing gases) that may be used in the present invention include exothermic and endothermic blowing agents. Examples of exothermic chemical blowing agents suitable for use in the present invention include, but are not limited to, azodicarbonate, p,p-oxybis(benzene) sulfonyl hydrazide, p-toluene sulfonyl hydrazide, p-toluene sulfonyl semicarbazide, dinitrosopentamethyltetramine, and 5-phenyltetrazole. Non-limiting examples of suitable endothermic chemical blowing agents include sodium bicarbonate and sodium borohydride. Some commercially available foaming agents combine a mixture of endo- and exo-thermic foaming agents. Examples of such combined foaming agents include the GMA series from Kibbe Chem Engineered Blowing Agents and Colorants, Inc and the Forticell series from Americhem, Inc. Other suitable chemical blowing agents include compounds that undergo a change of state at the desired foaming temperature, such as, but not limited to, hydroflouro compounds. Supercritical gases such as supercritical CO₂, N₂, or any other gas that may be pressurized into a liquid may alternatively be added as blowing agents through the conduit 26 and into the extruder 10. In addition, air may be utilized as a blowing agent.

It is considered to be within the purview of the invention to pre-blend a portion of the foaming agent with the polymeric resin. For example, approximately 50-75% of the foaming agent may be pre-blended with the resin. The remaining 50-25% of the foaming agent may then be added directly to the barrel of the extruder (not shown). By adding a portion of the blowing agent downstream of the resin/fiber feed hopper 20, the amount of foaming agent added to the polymer resin and ultimately into the final product, can be accurately monitored and adjusted as necessary throughout the extrusion process.

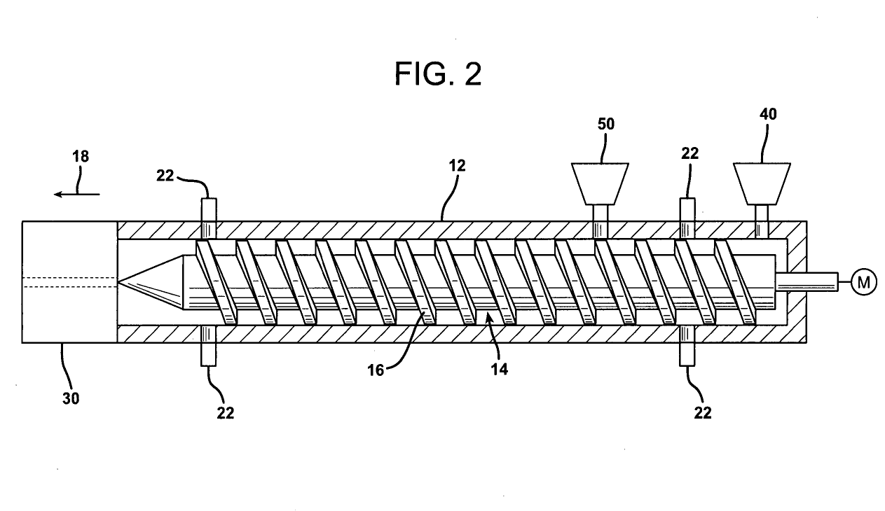

As shown in FIG. 1, the resin mixture/reinforcement fiber feed hopper 20 is positioned at the end of the extruder 10 opposing the extrusion die 30. In an alternate embodiment depicted in FIG. 2, a resin feed hopper 40 and a reinforcement fiber hopper 50 are positioned at the end of the extruder 10 opposing the extrusion die 30, with the reinforcement fiber hopper 50 positioned downstream from the resin feed hopper 40. The term “downstream” as used herein refers to the direction of resin and fiber flow through the barrel 12. Thus, in this embodiment, the polymeric resin, foaming agent, and optional colorant are added independently of the reinforcement fiber. By adding the polymeric resin prior to the addition of the reinforcement fibers, the resin is at least partially melted by the mechanical action of the screw 14 before it is mixed with the reinforcement fibers. This “pre-melting” permits for an easier mixing of the resin and the reinforcement fibers into a substantially homogenous mass and assists in reducing the wear on the extruder due to abrasion by the glass fibers. In addition, when adding the reinforcement fibers downstream of the resin mixture, it may be desirable to utilize a longer extrusion apparatus than used when the resin mixture and reinforcement fibers are added together through a single feedthroat (as depicted in FIG. 1) to permit thorough mixing (compounding) of the resin and reinforcement fibers. Alternatively, wet use chopped fibers may be used with the present invention as described in copending applications Ser. Nos. 10/991,278 and 11/020,374, which are incorporated herein by reference in their entirety.

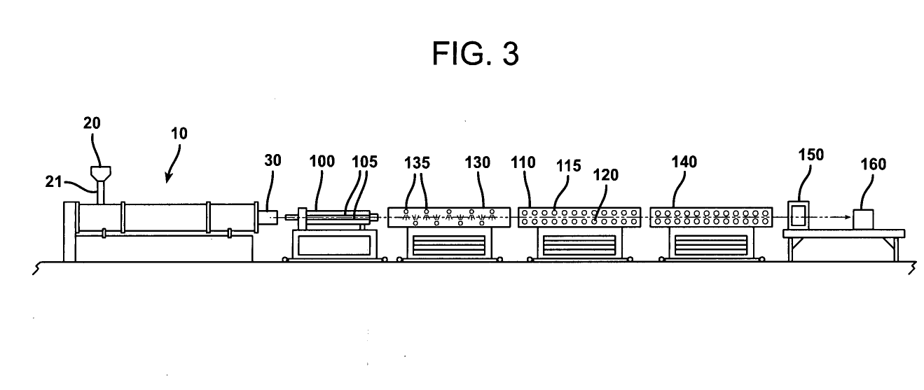

A schematic illustration of an exemplary extrusion line according to the instant invention is shown in FIG. 3. The reinforcement fibers, mixed resin formulation, the foaming agent, and any desired colorants are mixed and extruded into the shaping die as described above. As the extrudate exits the shaping die 30 and enters a zone of reduced pressure, it begins to foam. The foaming extrudate is pulled at a substantially constant speed into a calibrator 100 by a pulling apparatus 110. The pulling apparatus 110 may include a plurality of power driven upper and lower rollers 115, 120 that grip and pull the extrudate from the shaping die 30 through at least one calibrator 100 and cooling tank 130. Other examples of suitable pulling apparatuses include a track puller (not shown) that contains rubber tracks above and below the extrudate for gripping and pulling the extrudate down the extrusion line and caterpillar type belts for that grab and pull the extrudate down the line.

The desired shape of the foamed, reinforced product is formed in the die 30 and is maintained in that shape in the calibrator 100 until the polymeric melt is cool enough to hold the shape. The molten extrudate exiting the shaping die 30 possesses a foaming pressure that continues to build within the calibrator 100 until quenching begins (e.g., stopping the foaming process such as by cooling). In some exemplary embodiments, more than one calibrator is used to form shape of the final product. As the foaming pressure builds, the molten extrudate is forced against a fixed, cooled internal surface which sizes or calibrates the extrudate to the desired shape. In addition, the cooled internal surface cools the surface of the foaming extrudate to form a high-density skin. It is preferred that the skin be of a sufficient density and thickness to prevent molten extrudate in the core from bulging or bursting through the skin as it exits the calibrator(s) 100. The cooled internal surface of the calibrator 100 may be water, gas, liquid coolant or air- cooled channels 105. A vacuum (not shown) may also be used to pull the external surface of the molten extrudate to the cooled surface or surfaces of the cooled channels 105 within the calibrator 100 and calibrate the extrudate.

To further cool the shaped extrudate, it may be passed through at least one cooling tank 130 having a length sufficient to cool the extrudate and set it into its formed shape. Preferably, the cooling tank 130 cools the extrudate with minimal stress on the extrudate. In at least one embodiment, the cooling tank(s) 130 contains waters sprays 135 that spray water onto the shaped extrudate. In another embodiment of the present invention, the cooling tank(s) contain a water bath (not shown) through which the extrudate is passed to cool and set the extrudate.

The cooled, shaped extrudate may be passed through an embosser 140 give the shaped extrudate a desired surface finish. The embosser may be a two roll device in which at least one of the rolls contains a design. The design may be carved or etched into the roll. The second roll is opposed to the first roll so that pressure may be used to apply the design to the formed extrudate. The rolls may be held at a controlled temperature to assist in the embossing process. In an alternate embodiment (not illustrated), an embosser/puller combination may be utilized. In an embosser/puller combination, the embosser has an apparatus (such as belts) positioned to pull the extrudate down the extrusion line. In such an embodiment, a separate puller may or may not be utilized.

After exiting the embosser 140, the extrudate may pass through a perforator 150 which punches, drills or routes holes or slots in the extruded material to serve as nailing slots or holes. After exiting the perforator 150, the extrudate may be passed through a cut off and trimming apparatus 160. Here, the extrudate may be cut into desired lengths and/or sizes and the lateral edges may be trimmed to form the final product (e.g., a siding product). The cut off and trimming apparatus 160 may be mounted on a moving carriage that moves with the extrudate to produce a smooth straight cut at a desired angle. It is desirable that the cut-off device be electronically controlled to produce a cut piece having a desired length. The final product may be stacked on a packing table (not shown) for packaging and subsequent shipping.

In a preferred embodiment, the extruded composite product is a reinforced composite siding product with a thickness of approximately 0.22-0.25 inches, a density of about 0.6 to 0.9 g/cc, and a glass content of approximately 8 to 15% by weight of the product. The siding product may have a coefficient of thermal expansion in the range of 12-25×10⁻⁶ in/in/° F., preferably in the range of 14-20 ×10⁻⁶ in/in/° F. The thickness may vary depending on the appearance and characteristics/properties desired. For example a flat or tapered slab may be formed with a thickness between ⅛ inch and ¾ inch. The extruded product may have a weatherable polymer cap or laminate to protect the siding product from adverse environmental effects. The width (vertical height in the installed position) of the preferred siding product will depend upon the desired profile design but may range from about 4 to about 20 inches. However, one skilled in the art appreciates a panel may be formed having a height with multiple formations. In a most preferred embodiment, the foamed, reinforced cladding product has a unique nailing hem and horizontal panel locking system as extruded, thus eliminating the need for face nailing. This horizontal panel locking system together with the rigid reinforced material (e.g., glass fibers) also provides wind resistance. The foamed, reinforced siding product also has a unique vertical interlocking system to minimize or prevent separation during heating and cooling after the siding products are placed on the building.

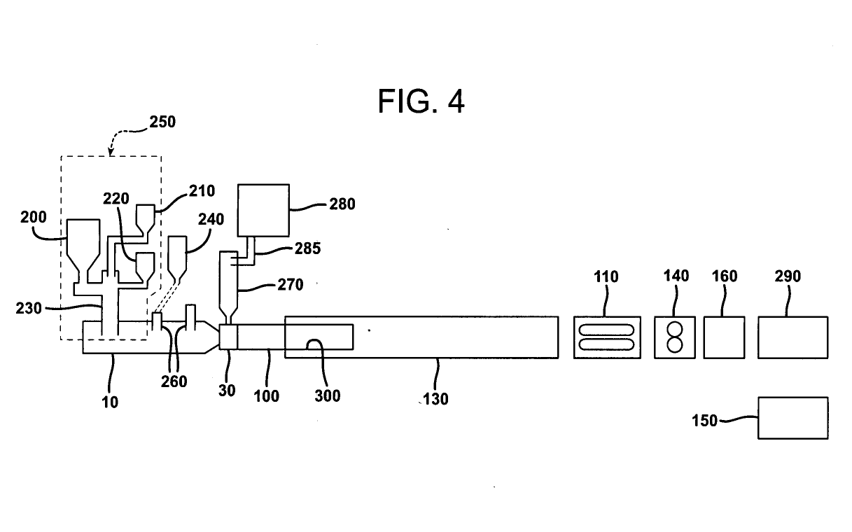

A cap may be co-extruded with the foamed, reinforced product, as depicted in the exemplary extrusion line shown in FIG. 4. In the embodiment illustrated in FIG. 4, a resin feed hopper 200, a reinforcement fiber feed hopper 210, and a color feed hopper 220 are in fluid communication with the extruder 10 via feedthroat 230. Thus, in this embodiment, the resin mixture, the reinforcement fibers, and colorants (if desired) are added to the extruder 10 at substantially the same time. It is to be noted that the phrase “substantially the same time” as used herein is meant to indicate that the reinforcement fibers and polymer resin(s) are fed into the extruder 10 at the same time or at nearly the same time. The foaming agent may be added to the to the extruder with the resin mixture via the resin feed hopper 200. In an alternative embodiment, a portion of the foaming agent is pre-blended with the polymeric resin and the remainder of the foaming agent may be added downstream of the main feed system 250, such as by the optional feed hopper 240. Vents 260 are used to allow trapped gases such as air or water vapor to escape the extruder 10.

The optional feed hopper 240 may also be used to feed additional reinforcement fibers (e.g., glass fibers), colorants, or any on-line additive downstream of the main feed system 250. It is to be appreciated that the reinforcement fibers may be fed through optional feed hopper 240 and not through the reinforcement fiber hopper 210. Such an embodiment would permit for a partial melting of the polymeric resin prior to the addition of the reinforcement fibers, thereby reducing wear on the extruder. In addition, adding the reinforcement fibers downstream by feed hopper 240 may permit the reinforcement fibers to retain more of their original chopped length and may not break or degrade such as when the reinforcement fibers are added with the resin fiber mixture via feedthroat 230. This retention of the length of the glass fibers may result in a lower coefficient of thermal expansion of the final product.

A cap extruder 270 is positioned on the on the extrusion line to co-extrude a cap. As illustrated in FIG. 4, cap stock (not shown) may be fed from a cap stock feed hopper 280 through a feedthroat 285 and into the cap extruder 270. Color pellets may be fed into the cap extruder 270 from color pellet hopper (not shown) to give the cap a desired color or appearance. The molten cap stock mixture (not shown) that exits the extruder 270 is conveyed to the die 30. To co-extrude a cap, the cap formed from the cap stock and the extrudate formed from the polymeric resin/fiber mixture from the extruder 10 exit the die 30 at substantially the same time. The cap may have a thickness from approximately 0.002-0.02 inches, and preferably a thickness from 0.004 to 0.01 inches. The cap forms a weather barrier to help protect the composite siding product from harmful effects caused by environmental factors such as sun, rain, and wind. Suitable weatherable cap materials include acrylic resins based upon methyl methacrylate, poly(butylacrylate-styrene-acrylonitrile), polyvinylidene fluoride, polyvinylfloride, and SAN, a copolymer of styrene and acrylonitrile. In at least one preferred embodiment, the cap material is an acrylic cap formed of Acryliguard CS-113 or CS-114, which are commercially available from Rohm and Haas Company. In an alternate embodiment (not illustrated), a weatherable film (e.g., blends of an acrylic and polyvinylidenefluoride resins) may be laminated onto the final product instead of co-extruding a cap. For the application of a decorated pattern, the pattern may be printed and then laminated.

The extrudate exiting the die 30 is pulled at a substantially constant speed by a pulling apparatus 110 into a calibrator 100 by a pulling apparatus 110. Optionally, the extrude is pulled through a second calibrator 300. Next, the extrudate is passed through at least one cooling tank 130 to cool the extrudate and set it into the predetermined, desired shape. The cooled and set extrudate may then be passed through an embosser 140 which places a design on the extrudate so that the final product formed has an aesthetically pleasing surface.

The extrudate may then pass through a cut-off/trimming apparatus 160 where the extrudate may be cut into discrete lengths. The foamed, reinforced product (not shown) may then be placed on a collection table 290. The product may then be passed through a perforator 150 which punches or drills holes (voids) in the extruded material to serve as nailing slots. The final product may be stacked on a packing table (not shown) for packaging and subsequent shipping.

The composite siding product formed from the mixed resin formulation described herein offers numerous advantages in the market place. For example, the foamed, reinforced composite siding product incorporates the advantages of traditional thin wall solid vinyl siding products the inventive siding product is lightweight, flexible, easy to install, is low maintenance, color fast, and vermin and insect resistant. In addition, the light weight of the reinforced, foamed siding product permits for ease of installation on new construction and may permit its installation over old siding on remodeling projects, unlike conventional cement siding products that require the old siding to be removed in order to properly support the siding product. Brick and stone require a foundation in order to support them on the face of the building.

The inventive siding product also has the advantages of strength, toughness, wind resistance, and durability. The flexibility of the reinforced, foamed siding product permits bending of the siding when necessary (e.g., during shipping, handling, and installation) and does not suffer the handling damage observed with wood or conventional cement siding products. In addition, the reinforcement fibers in the siding product provide dimensional stability and strength.

The foamed nature of the siding product allows for a cladding product to be manufactured at a weight that it is easy to install yet is strong enough to withstand substantial windloads. The foamed, reinforced siding product exhibits a tight cell structure that imparts robustness to the siding product that is accentuated by the use of high aspect ratio fillers and reinforcement fiber (e.g., glass fibers). In addition, the closed cell foam structure keeps water and moisture out of the siding product, thereby reducing or even eliminating freeze/thaw effects that damage conventional exterior cladding products. In addition, the inventive reinforced, foamed siding product does not require painting and/or caulking to prevent moisture and freeze/thaw damage. The chemical and environmental resistance of the cap coat also protects the inventive siding products from degradation. Further, the chemical make-up of the siding products make them naturally resistance to both vermin and insects. Because the foamed, reinforced siding product is colored entirely through the product, the inventive siding product will hide most scratches and dings that may occur in the surface of the siding product over time and use. In addition, an embossing pattern (e.g., natural wood-like embossing pattern) provides a surface that will hide minor blemishes caused by environmental or other factors.

Once installed the inventive cladding product is very low maintenance and requires only occasional washing to maintain a new appearance. The unique design of the nailing hem and locking system (not shown in the figures) permits the inventive cladding product to be “floated” on the wall, rather than hard nailed, thus hiding construction defects and irregular surfaces. The siding product is self leveling during installation and do not require face nailing, caulking, or painting. The inventive siding product has nail slots (not shown in the figures) and is therefore not subject to nailing damage that is typically observed when wood or cement siding is nailed too close to the edge of the siding.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

Comparison of Various Aspect Ratio Fillers in Inventive Resin Formulations

The resin formulations set forth in Tables 1-13 were prepared in blenders as described generally below. To prepare resin formulations A-M, the PVC resin and stabilizer (TM 186) were added to a pilot line high speed blender and mixed at high speed until the temperature reached approximately 150° F. At that time, the lubricants (Adva wax 280, A.C. 629a, and Dover Lube Ca 21) and processing aid (Paraloid K-400) were added and blended at high speed until the mixture reached approximately 170° F. The filler (e.g., diatomaceous earth, perlite, mica, wollastonite, mineral wool, and/or calcium carbonate, depending on the formulation desired) was added and the mixture was further blended at high speed to a temperature of about 210° F. The formulation was then transferred to a low intensity mixture and blended at low speed until the temperature reached approximately 150° F.

TABLE 1
Resin Formulation A (diatomaceous earth)

| | % by Weight of |
|---|---|
| Chemical | Active Solids |
| PVC Resin 216^{(a)} | 77.76 |
| Celatom MW27^{(b)} | 11.66 |
| Paraloid K-400^{(c)} | 7.00 |
| Adva wax 280^{(d)} | 1.32 |
| TM 186^{(e)} | 0.93 |
| Dover Lube Ca 21^{(f)} | 1.17 |
| A.C. 629a^{(g)} | 0.16 |
| Total | 100.00 |

^{(a)}polyvinyl chloride resin (PVC) (Oxy Chem)
^{(b)}diatomaceous earth (Eagle-Pricher)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 1a

| | |
|---|---|
| Coefficient of Thermal Expansion ((in/in/° F.) × 10⁻⁶) | 21.1 |
| Density (g/cc) | 0.79 |
| Glass Percent | 10 |

TABLE 2
Resin Formulation B (perlite)

| | % by Weight of |
|---|---|
| Chemical | Active Solids |
| PVC Resin 216^{(a)} | 77.76 |
| Celatom 1200P^{(b)} | 11.66 |
| Paraloid K-400^{(c)} | 7.00 |
| Adva wax 280^{(d)} | 1.32 |
| TM 186^{(e)} | 0.93 |
| Dover Lube Ca 21^{(f)} | 1.17 |
| A.C. 629a^{(g)} | 0.16 |
| Total | 100.00 |

^{(a)}polyvinyl chloride resin (PVC) (Oxy Chem)
^{(b)}perlite (Eagle-Pricher)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 2a

| | |
|---|---|
| Coefficient of Thermal Expansion ((in/in/° F.) × 10⁻⁶) | 17.0 |
| Density (g/cc) | 0.9 |
| Glass Percent | 10 |

TABLE 3
Resin Formulation C (mica)

| | % by Weight of |
|---|---|
| Chemical | Active Solids |
| PVC Resin 216^{(a)} | 77.76 |
| CD-2200^{(b)} | 11.66 |
| Paraloid K-400^{(c)} | 7.00 |
| Adva wax 280^{(d)} | 1.32 |
| TM 186^{(e)} | 0.93 |
| Dover Lube Ca 21^{(f)} | 1.17 |
| A.C. 629a^{(g)} | 0.16 |
| Total | 100.00 |

^{(a)}polyvinyl chloride resin (PVC) (Oxy Chem)
^{(b)}mica (Georgia Industrial Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 3a

| | |
|---|---|
| Coefficient of Thermal Expansion ((in/in/° F.) × 10⁻⁶) | 18.9 |
| Density (g/cc) | 0.79 |
| Glass Percent | 10 |

TABLE 4
Resin Formulation D (mica)

| | % by Weight of |
|---|---|
| Chemical | Active Solids |
| PVC Resin 216^{(a)} | 77.76 |
| CD-3200^{(b)} | 11.66 |
| Paraloid K-400^{(c)} | 7.00 |
| Adva wax 280^{(d)} | 1.32 |
| TM 186^{(e)} | 0.93 |
| Dover Lube Ca 21^{(f)} | 1.17 |
| A.C. 629a^{(g)} | 0.16 |
| Total | 100.00 |

^{(a)}polyvinyl chloride resin (PVC) (Oxy Chem)
^{(b)}mica (Georgia Industrial Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 4a

| | |
|---|---|
| Coefficient of Thermal Expansion ((in/in/° F.) × 10⁻⁶) | 21.5 |
| Density (g/cc) | 0.725 |
| Glass Percent | 10 |

TABLE 5
Resin Formulation E (wollastonite)

| | % by Weight of |
|---|---|
| Chemical | Active Solids |
| PVC Resin 216^{(a)} | 77.76 |
| NyGloss 8^{(b)} | 11.66 |
| Paraloid K-400^{(c)} | 7.00 |
| Adva wax 280^{(d)} | 1.32 |
| TM 186^{(e)} | 0.93 |
| Dover Lube Ca 21^{(f)} | 1.17 |
| A.C. 629a^{(g)} | 0.16 |
| Total | 100.00 |

^{(a)}polyvinyl chloride resin (PVC) (Oxy Chem)
^{(b)}wollastonite (NYCO)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 5a

| | |
|---|---|
| Coefficient of Thermal Expansion ((in/in/° F.) × 10⁻⁶) | 17.9 |
| Density (g/cc) | 0.82 |
| Glass Percent | 10 |

TABLE 6
Resin Formulation F (wollastonite)

| | % by Weight of |
|---|---|
| Chemical | Active Solids |
| PVC Resin 216^{(a)} | 77.76 |
| NyGloss 4W^{(b)} | 11.66 |
| Paraloid K-400^{(c)} | 7.00 |
| Adva wax 280^{(d)} | 1.32 |
| TM 186^{(e)} | 0.93 |
| Dover Lube Ca 21^{(f)} | 1.17 |
| A.C. 629a^{(g)} | 0.16 |
| Total | 100.00 |

^{(a)}polyvinyl chloride resin (PVC) (Oxy Chem)
^{(b)}wollastonite (NYCO)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 6a

| | |
|---|---|
| Coefficient of Thermal Expansion ((in/in/° F.) × 10⁻⁶) | 19.5 |
| Density (g/cc) | 0.84 |
| Glass Percent | 10 |

TABLE 7
Resin Formulation G (mineral wool)

| | % by Weight of |
|---|---|
| Chemical | Active Solids |
| PVC Resin 216^{(a)} | 80.91 |
| PMF LS-B^{(b)} | 8.09 |
| Paraloid K-400^{(c)} | 7.28 |
| Adva wax 280^{(d)} | 1.38 |
| TM 186^{(e)} | 0.97 |
| Dover Lube Ca 21^{(f)} | 1.21 |
| A.C. 629a^{(g)} | 0.16 |
| Total | 100.00 |

^{(a)}polyvinyl chloride resin (PVC) (Oxy Chem)
^{(b)}mineral wool (Sloss Industries)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 7a

| | |
|---|---|
| Coefficient of Thermal Expansion ((in/in/° F.) × 10⁻⁶) | 19.6 |
| Density (g/cc) | 0.84 |
| Glass Percent | 10 |

TABLE 8
Resin Formulation H (mineral wool/calcium carbonate)

| | % by Weight of |
|---|---|
| Chemical | Active Solids |
| PVC Resin 216^{(a)} | 69.64 |
| PMF LS-B^{(b)} | 3.48 |
| Super-pflex 1000^{(c)} | 17.41 |
| Paraloid K-400^{(d)} | 6.27 |
| Adva wax 280^{(e)} | 1.18 |
| TM 186^{(f)} | 0.84 |
| Dover Lube Ca 21^{(g)} | 1.04 |
| A.C. 629a^{(h)} | 0.14 |
| Total | 100.00 |

^{(a)}polyvinyl chloride resin (PVC) (Oxy Chem)
^{(b)}mineral wool (Sloss Industries)
^{(c)}calcium carbonate (Specialty Minerals)
^{(d)}processing aid (Rohm & Haas)
^{(e)}lubricant (Rohm & Haas)
^{(f)}stabilizer (Rohm & Haas)
^{(g)}calcium stearate (Dover Chem)
^{(h)}oxidized polyethylene (OPE) (Honeywell)

TABLE 8a

| | |
|---|---|
| Coefficient of Thermal Expansion ((in/in/° F.) × 10⁻⁶) | 17.7 |
| Density (g/cc) | 0.85 |
| Glass Percent | 10 |

TABLE 9
Resin Formulation I (mineral wool/calcium carbonate)

| | % by Weight of |
|---|---|
| Chemical | Active Solids |
| PVC Resin 216^{(a)} | 77.76 |
| PMF LS-B^{(b)} | 7.78 |
| Super-pflex 1000^{(c)} | 19.44 |
| Paraloid K-400^{(d)} | 7.00 |
| Adva wax 280^{(e)} | 1.32 |
| TM 186^{(f)} | 0.93 |
| Dover Lube Ca 21^{(g)} | 1.17 |
| A.C. 629a^{(h)} | 0.16 |
| Total | 115.55 |

^{(a)}polyvinyl chloride resin (PVC) (Oxy Chem)
^{(b)}mineral wool (Sloss Industries)
^{(c)}calcium carbonate (Specialty Minerals)
^{(d)}processing aid (Rohm & Haas)
^{(e)}lubricant (Rohm & Haas)
^{(f)}stabilizer (Rohm & Haas)
^{(g)}calcium stearate (Dover Chem)
^{(h)}oxidized polyethylene (OPE) (Honeywell)

TABLE 9a

| | |
|---|---|
| Coefficient of Thermal Expansion ((in/in/° F.) × 10⁻⁶) | 18.4 |
| Density (g/cc) | 0.83 |
| Glass Percent | 10 |

TABLE 10
Resin Formulation J (mica/calcium carbonate)

| | % by Weight of |
|---|---|
| Chemical | Active Solids |
| PVC Resin 216^{(a)} | 69.64 |
| CD-3200^{(b)} | 10.45 |
| Super-pflex 1000^{(c)} | 10.45 |
| Paraloid K-400^{(d)} | 6.27 |
| Adva wax 280^{(e)} | 1.18 |
| TM 186^{(f)} | 0.84 |
| Dover Lube Ca 21^{(g)} | 1.04 |
| A.C. 629a^{(h)} | 0.14 |
| Total | 100.00 |

^{(a)}polyvinyl chloride resin (PVC) (Oxy Chem)
^{(b)}mica (Georgia Industrial minerals)
^{(c)}calcium carbonate (Specialty Minerals)
^{(d)}processing aid (Rohm & Haas)
^{(e)}lubricant (Rohm & Haas)
^{(f)}stabilizer (Rohm & Haas)
^{(g)}calcium stearate (Dover Chem)
^{(h)}oxidized polyethylene (OPE) (Honeywell)

TABLE 10a

| | |
|---|---|
| Coefficient of Thermal Expansion ((in/in/° F.) × 10⁻⁶) | 18.6 |
| Density (g/cc) | 0.78 |
| Glass Percent | 10 |

TABLE 11
Resin Formulation K (calcium carbonate)

| | % by Weight of |
|---|---|
| Chemical | Active Solids |
| PVC Resin 5305^{(a)} | 71.12 |
| Super pflex 1000^{(b)} | 17.78 |
| Paraloid K-400^{(c)} | 7.82 |
| Adva wax 280^{(d)} | 1.21 |
| TM 186^{(e)} | 0.85 |
| Dover Lube Ca 21^{(f)} | 1.07 |
| A.C. 629a^{(g)} | 0.14 |
| Total | 100.00 |

^{(a)}polyvinyl chloride resin (PVC) (Georgia Gulf)
^{(b)}calcium carbonate (Specialty Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}oxidized polyethylene (OPE) (Honeywell)

TABLE 11a

| | |
|---|---|
| Coefficient of Thermal Expansion ((in/in/° F.) × 10⁻⁶) | 19.4 |
| Density (g/cc) | 0.6 |
| Glass Percent | 10 |

TABLE 12
Resin Formulation L (talc/calcium carbonate)

| | % by Weight of |
|---|---|
| Chemical | Active Solids |
| PVC Resin 5305^{(a)} | 70.37 |
| CD-3200^{(b)} | 7.04 |
| Super-pflex 1000^{(c)} | 10.56 |
| K-175^{(d)} | 1.06 |
| Paraloid K-400^{(e)} | 7.74 |
| Adva wax 280^{(f)} | 1.20 |
| TM 186^{(g)} | 0.84 |
| Dover Lube Ca 21^{(h)} | 1.06 |
| A.C. 629a⁽ⁱ⁾ | 0.14 |
| Total | 100.00 |

^{(a)}polyvinyl chloride resin (PVC) (Oxy Chem)
^{(b)}talc (Specialty Minerals)
^{(c)}calcium carbonate (Specialty Minerals)
^{(d)}processing aid (Rohm & Haas)
^{(e)}processing aid (Rohm & Haas)
^{(f)}lubricant (Rohm & Haas)
^{(g)}stabilizer (Rohm & Haas)
^{(h)}calcium stearate (Dover Chem)
⁽ⁱ⁾oxidized polyethylene (OPE) (Honeywell)

TABLE 12a

| | |
|---|---|
| Coefficient of Thermal Expansion ((in/in/° F.) × 10⁻⁶) | 20.0 |
| Density (g/cc) | 0.58 |
| Glass Percent | 10 |

TABLE 13
Resin Formulation M (talc/calcium carbonate)

| | % by Weight of |
|---|---|
| Chemical | Active Solids |
| PVC Resin 5305^{(a)} | 71.12 |
| CD-3200^{(b)} | 7.11 |
| Super-pflex 1000^{(c)} | 10.67 |
| Paraloid K-400^{(d)} | 7.82 |
| Adva wax 280^{(e)} | 1.21 |
| TM 186^{(f)} | 0.85 |
| Dover Lube Ca 21^{(g)} | 1.07 |
| A.C. 629a^{(h)} | 0.14 |
| Total | 100.00 |

^{(a)}polyvinyl chloride resin (PVC) (Georgia Gulf)
^{(b)}talc (Specialty Minerals)
^{(c)}calcium carbonate (Specialty Minerals)
^{(d)}processing aid (Rohm & Haas)
^{(e)}lubricant (Rohm & Haas)
^{(f)}stabilizer (Rohm & Haas)
^{(g)}calcium stearate (Dover Chem)
^{(h)}oxidized polyethylene (OPE) (Honeywell)

TABLE 13a

| | |
|---|---|
| Coefficient of Thermal Expansion ((in/in/° F.) × 10⁻⁶) | 18.1 |
| Density (g/cc) | 0.59 |
| Glass Percent | 10 |

Each of the resin formulations set forth in Tables 1-13 were extruded on a KM-60 Krauss Maffei twin screw extruder with the Kibbe Chem GM-416 blowing agent and Owens Coming 165A-10P 6 mm DUCS glass fibers as described in detail above to form a foamed, glass reinforced siding product. Tables 1a-13a set forth the coefficient of thermal expansion (CTE) and density of the siding products formed from the resin formulations of Tables 1-13. Possessing a low CTE is a desired property in siding products because a low CTE correlates to minimal movement of the siding once it is placed onto the building. As shown in Tables 1-13a, the designated fillers used in the inventive formulations assisted in creating a reinforced, foamed siding product that had coefficient of thermal expansions in the desired range of from 12-25 ×10⁻⁶ in/in/° F.

### Example 2

Use of Glass Fibers, Calcium Carbonate and Talc Filler to Reduce Coefficient of Thermal Expansion

The resin formulations N-Q set forth in Tables 14-17 were prepared in blenders as described in Example 1 set forth above. In particular, the PVC resin and stabilizer (TM 186) were added to a high speed blender and mixed at high speed until the temperature reached approximately 150 ° F. At that time, the lubricants (Adva wax 280, A.C. 629a, and Dover Lube Ca 21) and processing aid (Paraloid K-400) were added and blended at high speed until the mixture reached approximately 170° F. The filler (i.e., precipitated calcium carbonate) was added and the mixture was further blended at high speed to a temperature of about 210° F. The formulation was then transferred to a low intensity mixture and blended at low speed until the temperature reached approximately 150° F.

TABLE 14
Resin Formulation N

| | | % by Weight |
|---|---|---|
| Chemical | PPH | of Active Solids |
| PVC Resin 216^{(a)} | 100 | 71.12 |
| Super-flex 1000^{(b)} | 25 | 17.78 |
| Paraloid K-400^{(c)} | 11 | 7.82 |
| Adva wax 280^{(d)} | 1.7 | 1.2 |
| TM 186^{(e)} | 1.2 | 0.85 |
| Dover Lube Ca 21^{(f)} | 1.5 | 1.07 |
| A.C. 629a^{(g)} | 0.2 | 0.14 |

^{(a)}polyvinyl chloride resin (PVC) (Oxy Chem)
^{(b)}calcium carbonate (Specialty Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}lubricant (Honeywell)

TABLE 14a

| | Sample 1 | Sample 2 |
|---|---|---|
| Coefficient of Thermal | 22.9 | 17.1 |
| Expansion ((in/in/° F.) × 10⁻⁶) | | |
| Density (g/cc) | 0.7 | 0.81 |
| Glass Percent | 10 | 15 |

TABLE 15
Resin Formulation O

| | | % by Weight |
|---|---|---|
| Chemical | PPH | of Active Solids |
| PVC Resin 216^{(a)} | 100 | 71.12 |
| Super-flex 1000^{(b)} | 15 | 10.67 |
| MV 607^{(c)} | 10 | 7.11 |
| Paraloid K-400^{(c)} | 11 | 7.82 |
| Adva wax 280^{(d)} | 1.7 | 1.21 |
| TM 186^{(f)} | 1.2 | 0.85 |
| Dover Lube Ca 21^{(g)} | 1.5 | 1.07 |
| A.C. 629a^{(h)} | 0.2 | 0.14 |

^{(a)}polyvinyl chloride resin (PVC) (Oxy Chem)
^{(b)}calcium carbonate (Specialty Minerals)
^{(c)}talc (Specialty Minerals)
^{(d)}processing aid (Rohm & Haas)
^{(e)}lubricant (Rohm & Haas)
^{(f)}stabilizer (Rohm & Haas)
^{(g)}calcium stearate (Dover Chem)
^{(h)}lubricant (Honeywell)

TABLE 15a

| | Sample 3 | Sample 4 | Sample 5 |
|---|---|---|---|
| Coefficient of Thermal | 20.6 | 15.9 | 23.6 |
| Expansion ((in/in/° F.) × 10^{31 6}) | | | |
| Density (g/cc) | 0.7 | 0.875 | 0.61 |
| Glass Percent | 10 | 15 | 5 |

TABLE 16
Resin Formulation P

| | | % by Weight |
|---|---|---|
| Chemical | PPH | of Active Solids |
| PVC Resin 216^{(a)} | 100 | 71.12 |
| Super-flex 1000^{(b)} | 10 | 7.11 |
| MV 607^{(c)} | 15 | 10.67 |
| Paraloid K-400^{(d)} | 11 | 7.82 |
| Adva wax 280^{(e)} | 1.7 | 1.21 |
| TM 186^{(f)} | 1.2 | 0.85 |
| Dover Lube Ca 21^{(g)} | 1.5 | 1.07 |
| A.C. 629a^{(h)} | 0.2 | 0.14 |

^{(a)}polyvinyl chloride resin (PVC) (Oxy Chem)
^{(b)}calcium carbonate (Specialty Minerals)
^{(c)}talc (Specialty Minerals)
^{(d)}processing aid (Rohm & Haas)
^{(e)}lubricant (Rohm & Haas)
^{(f)}stabilizer (Rohm & Haas)
^{(g)}calcium stearate (Dover Chem)
^{(h)}lubricant (Honeywell)

TABLE 16a

| | Sample 6 | Sample 7 | Sample 8 |
|---|---|---|---|
| Coefficient of Thermal | 22.3 | 19.7 | 15.5 |
| Expansion ((in/in/° F.) × 10⁻⁶) | | | |
| Density (g/cc) | 0.6 | 0.71 | 0.83 |
| Glass Percent | 5 | 10 | 15 |

TABLE 17
Resin Formulation Q

| | | % by Weight |
|---|---|---|
| Chemical | PPH | of Active Solids |
| PVC Resin 216^{(a)} | 100 | 71.12 |
| MV 607^{(b)} | 25 | 17.78 |
| Paraloid K-400^{(c)} | 11 | 7.82 |
| Adva wax 280^{(d)} | 1.7 | 1.21 |
| TM 186^{e)} | 1.2 | 0.85 |
| Dover Lube Ca 21^{(f)} | 1.5 | 1.07 |
| A.C. 629a^{(g)} | 0.2 | 0.14 |

^{(a)}polyvinyl chloride resin (PVC) (Oxy Chem)
^{(b)}talc (Specialty Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}lubricant (Honeywell)

TABLE 17a

| | Sample 9 | Sample 10 | Sample 11 |
|---|---|---|---|
| Coefficient of Thermal | 14.1 | 19.8 | 17.0 |
| Expansion ((in/in/° F.) × 10⁻⁶) | | | |
| Density (g/cc) | 0.9 | 0.61 | 0.74 |
| Glass Percent | 15 | 5 | 10 |

Each of the resin formulations set forth in Tables 14-17 were extruded with a blowing agent and glass fibers as described in detail above in Example 1 to form a foamed, glass reinforced siding product. Tables 14a-17a set forth the coefficient of thermal expansion (CTE), density, and glass percent of the siding products formed from the resin formulations of Tables 14-17. The results of the experiments demonstrated that adding glass fibers was the most efficient method of reducing the coefficient of liner expansion (CTE). By “efficient”, it is meant to reflect the percent of material added versus the amount of CTE reduction that occurred. The addition of talc was shown to be the next most efficient method to reduce the CTE. Calcium carbonate was shown to be the least effective of the components tested at reducing the CTE.

### Example 3

Low K-value Versus High K-value PVC Resins in Inventive Resin Formulations

The resin formulations set forth in Tables 18-20 were prepared in blenders as described above in Examples 1 and 2. In particular, the PVC resin (PVC Resin 216 or PVC Resin 5305 depending on the desired formulation) and stabilizer (TM 186) were added to a high speed blender and mixed at high speed until the temperature reached approximately 150° F. At that time, the lubricants (Adva wax 280, A.C. 629a, and Dover Lube Ca 21) and processing aid (Paraloid K-400) were added and blended at high speed until the mixture reached approximately 170° F. The filler (i.e., calcium carbonate) was added and the mixture was further blended at high speed to a temperature of about 210° F. The formulation was then transferred to a low intensity mixture and blended at low speed until the temperature reached approximately 150° F.

TABLE 18
Resin Formulation R

| | | % by Weight |
|---|---|---|
| Chemical | PPH | of Active Solids |
| PVC Resin 216^{(a)} | 100 | 71.12 |
| MV 607^{(b)} | 25 | 17.78 |
| Paraloid K-400^{(c)} | 11 | 7.82 |
| Adva wax 280^{(d)} | 1.7 | 1.21 |
| TM 186^{e)} | 1.2 | 0.85 |
| Dover Lube Ca 21^{(f)} | 1.5 | 1.07 |
| A.C. 629a^{(g)} | 0.2 | 0.14 |

^{(a)}polyvinyl chloride resin (PVC) (Oxy Chem)
^{(b)}talc (Specialty Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}lubricant (Honeywell)

TABLE 18a

| | Sample 12 | Sample 13 |
|---|---|---|
| Density (g/cc) | 0.7 | 0.725 |
| Glass Percent | 10 | 10 |
| Average Cap Thickness | 0.008 | 0.12 |

TABLE 19
Resin Formulation S

| | | % by Weight |
|---|---|---|
| Chemical | PPH | of Active Solids |
| PVC Resin 216^{(a)} | 100 | 70.13 |
| MV 607^{(b)} | 25 | 17.53 |
| Paraloid K-400^{(c)} | 13 | 9.11 |
| Adva wax 280^{(d)} | 1.7 | 1.19 |
| TM 186^{e)} | 1.2 | 0.84 |
| Dover Lube Ca 21^{(f)} | 1.5 | 1.05 |
| A.C. 629a^{(g)} | 0.2 | 0.14 |

^{(a)}polyvinyl chloride resin (PVC) (Oxy Chem)
^{(b)}talc (Specialty Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}lubricant (Honeywell)

TABLE 19a

| | Sample 14 |
|---|---|
| Density (g/cc) | 0.71 |
| Glass Percent | 10 |
| Average Cap Thickness | 0.013 |

TABLE 20
Resin Formulation T

| | | % by Weight |
|---|---|---|
| Chemical | PPH | of Active Solids |
| PVC Resin 5305^{(a)} | 100 | 71.12 |
| MV 607^{(b)} | 25 | 17.78 |
| Paraloid K-400^{(c)} | 11 | 7.82 |
| Adva wax 280^{(d)} | 1.7 | 1.21 |
| TM 186^{e)} | 1.2 | 0.85 |
| Dover Lube Ca 21^{(f)} | 1.5 | 1.07 |
| A.C. 629a^{(g)} | 0.2 | 0.14 |

^{(a)}polyvinyl chloride resin (PVC) (Georgia Gulf)
^{(b)}talc (Specialty Minerals)
^{(c)}processing aid (Rohm & Haas)
^{(d)}lubricant (Rohm & Haas)
^{(e)}stabilizer (Rohm & Haas)
^{(f)}calcium stearate (Dover Chem)
^{(g)}lubricant (Honeywell)

TABLE 20a

| | Sample 15 | Sample 16 | Sample 17 |
|---|---|---|---|
| Density (g/cc) | 0.59 | 0.58 | 0.65 |
| Glass Percent | 10 | 10 | 10 |
| Average Cap Thickness | 0.011 | 0.008 | 0.006 |

Each of the resin formulations set forth in Tables 18-20 were co-extruded on a Krass Maffei KM-60 Twin Screw Extruder with glass fibers and a blended foaming agent composed of azodicarbonamide and sodium bicarbonate as described in detail above to form a foamed, glass reinforced siding product having an acrylic cap based upon polymethlymethacrylate. Tables 18a -20a set forth the density, glass percent, and average cap thickness of the siding products formed from the resin formulations of Tables 18-20. It can be seen from the Tables that the lower molecular weight resin PVC Resin 5305 resulted in lower density products due at least in part to lower processing viscosities as the product is foamed. The lower molecular weight PVC resin also resulted in the ability to reduce the amount of blowing agent needed in the formulation to form the final siding product. In addition, the lower molecular weight PVC resin also permitted the reduction of the thickness of the cap layer needed to maintain a uniform cap coverage.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A reinforced, foamed siding product comprising:
at least one foamed polymeric resinous material; and
glass fibers in an amount up to about 25% by weight of said foamed siding product.

2. The siding product of claim 1, further comprising:
at least one filler.

3. The siding product of claim 2, wherein said filler is selected from the group consisting of calcium carbonate, talc, aluminum trihydrate, clays, calcium silicate, graphite, kaolin, magnesium oxide, molybdenum disulfide, silica, slate powder, zinc salts, zeolites, calcium sulfate, barium salts, Portland cement, perlite, diatomaceous earth, mica, wollastonite, ground scrap glass fibers, flaked glass, nano-particles and mineral wool.

4. The siding product of claim 2, wherein said filler has an aspect a ratio of 5-50.

5. The siding product of claim 2, wherein said siding product has a coefficient of thermal expansion between 12-25×10⁻⁶ in/in/° F.

6. The siding product of claim 2, wherein said siding product has a coefficient of thermal expansion between 14-20×10⁻⁶ in/in/° F.

7. The siding product of claim 2, wherein said siding product has a coefficient of thermal expansion less than about 17×10⁻⁶ in/in/° F.

8. The siding product of claim 2, wherein said siding product has a coefficient of thermal expansion less than about 15×10⁻⁶ in/in/° F.

9. The siding product of claim 6, wherein said siding product has a density between about 0.6 to 0.9 g/cc

10. The siding product of claim 2, further comprising:
a processing aid;
one or more lubricants; and
a thermal stabilizer.

11. The siding product of claim 1, wherein said resinous material is a polymeric resin selected from the group consisting of polyvinyl chloride, chlorinated polyvinyl chloride, polyethylene, polypropylene, polycarbonates, polystyrene, styreneacrylonitrile, acrylonitrile butadiene styrene, acrylic/styrene/acrylonitrile tripolymer, polysulfone, polyurethane, polyphenylenesulfide, acetal resins, polyamides, polyaramides, polyimides, polyesters, polyester elastomers, acrylic acid esters, copolymers of ethylene and propylene, copolymers of styrene and butadiene, copolymers of vinylacetate and ethylene and combinations thereof.

12. The siding product of claim 1, wherein said resinous material has a weight average molecular weight of from approximately 50,000-100,000 g/mole.

13. The siding product of claim 1, wherein said resinous material is polyvinyl chloride, said polyvinyl chloride having a K-value of from 54-60.

14. The siding product of claim 10, wherein said resinous material, said filler, said processing aid, said one or more lubricants, and said thermal stabilizer comprise a mixed resin formulation, said mixed resin formulation including:
said resinous material in an amount from about 60-85% by weight of the active solids in the composition;
said filler in an amount up to 40% by weight of the active solids in the composition;
said processing aid in an amount from about 5-20% by weight of the active solids in the composition;
said one or more lubricants in an amount from about 0.5-5% by weight of the active solids in the composition; and
said thermal stabilizer in an amount from about 0.5-2.0% by weight of the active solids in the composition.

15. The siding product of claim 1, further comprising a cap formed of a cap stock material selected from the group consisting of acrylic resins based upon methyl methacrylate, poly(butylacrylate-styrene-acrylonitrile), polyvinylidene fluoride, polyvinylfluoride and copolymers of styrene and acrylonitrile.

16. The siding product of claim 1, further comprising at least one synthetic fiber selected from the group consisting of polyester, polyethylene terephthalate, polypropylene, polyparaphenylene terephthalamide, polyamide, aramid, polyimide, rayon, polyurethane and nylon fibers.

17. A method of forming a reinforced, foamed siding product comprising the steps of:
feeding a mixed resin formulation, a blowing agent, and glass fibers into a barrel of an extruder, said barrel encasing at least one rotatable screw having flights and extending substantially along a length of said barrel, said mixed resin formulation including:
a polymeric resinous material; and
a filler;
conveying said mixed resin formulation, said blowing agent, and said glass fibers along said at least one rotatable screw to at least partially melt said polymeric resinous material and form a molten mixture of said polymeric resinous material and said glass fibers;
passing said molten/resin fiber mixture through an extrusion die having a desired shape of said reinforced, foamed siding product to form an extrudate,
pulling said extrudate into a calibrator having said desired shape of said reinforced, foamed siding product, said extrudate having a foaming pressure that builds within said calibrator to expand said extrudate against internal walls of said calibrator and form said reinforced, foamed siding product.

18. The method of claim 17, wherein said mixed resin formulation further comprises:
a processing aid;
one or more lubricants; and
a thermal stabilizer.

19. The method of claim 18, wherein said mixed resin formulation comprises:
said resinous material in an amount from about 60-85% by weight of the active solids in the composition;
said filler in an amount up to 40% by weight of the active solids in the composition;
said processing aid in an amount from about 5-20% by weight of the active solids in the composition;
said one or more lubricants in an amount from about 0.5-5% by weight of the active solids in the composition; and
said thermal stabilizer in an amount from about 0.5-2.0% by weight of the active solids in the composition.

20. The method of claim 17, further comprising the step of:
cooling said reinforced, foamed siding product in a cooling tank to further set said reinforced, foamed siding product into said desired shape after said pulling step.

21. The method of claim 17, further comprising the step of:
passing said reinforced, foamed siding product through an embosser to give said reinforced, foamed siding product a desired surface finish.

22. The method of claim 17, further comprising the step of:
co-extruding a cap with said reinforced, foamed siding product.

23. The method of claim 22, wherein said co-extruding comprises the steps of:
feeding a cap stock into a cap extruder;
melting said cap stock in said cap extruder; and
conveying said melted cap stock to said extrusion die.

24. The method of claim 17, wherein at least a portion of said glass fibers are fed in said barrel of said extruder downstream of said mixed resin formulation and said blowing agent.

25. A process for preparing a reinforced, foamed siding product comprising the steps of:
forming a foamable mixture comprising a polymeric resinous material, a filler, a processing aid, one or more lubricants, a thermal stabilizer, and glass fibers; and
foaming said foamable mixture in a region of reduced pressure to form said reinforced, foamed siding product.

26. The process of claim 25, further comprising the step of:
pulling said foaming mixture into a calibrator having a desired shape of said reinforced, foamed siding product after said foaming step, said foaming mixture expanding against internal walls of said calibrator to form said reinforced, foamed siding product.

27. The process of claim 26, further comprising the step of:
conveying said foamable mixture along at least one screw extending substantially along a length of a barrel of an extruder to at least partially melt said polymeric resinous material and form a molten mixture of said polymeric resinous material and said glass fibers prior to said foaming step.

28. The process of claim 26, further comprising the step of:
co-extruding a cap with said reinforced, foamed siding product.

29. The process of claim 26, wherein at least a portion of said glass fibers are fed into said barrel downstream of said polymeric resinous material, said filler, said processing aid, said one or more lubricants, and said thermal stabilizer.

30. The process of claim 25, further comprising the step of:
passing said foamable mixture through an extrusion die having a desired shape of said reinforced, foamed siding product to form an extrudate prior to said foaming step.

31. The process of claim 25, wherein said foamable mixture further comprises a colorant or color pellets.

32. A composition for forming a reinforced, foamed siding product in an extrusion process comprising:
glass fibers in an amount up to about 25% by weight of said reinforced, foamed siding product;
a polymeric resinous material; and
a filler.

33. The composition of claim 32, further comprising:
a processing aid;
one or more lubricants; and
a thermal stabilizer.

34. The composition of claim 33, wherein:
said resinous material is present in said composition in an amount from about 60-85% by weight of the active solids in the composition
said filler is present in said composition in an amount up to 40% by weight of the active solids in the composition;
said processing aid is present in said composition in an amount from about 5-20% by weight of the active solids in the composition;
said one or more lubricants is present in said composition in an amount from about 0.5-5% by weight of the active solids in the composition; and
said thermal stabilizer is present in said composition in an amount from about 0.5-2.0% by weight of the active solids in the composition.

35. The composition of claim 34, wherein said resinous material has a weight average molecular weight of from approximately 50,000-100,000 g/mole.

36. The composition of claim 34, wherein said filler has an aspect a ratio of 5-50.

37. The composition of claim 36, wherein said siding product has a coefficient of thermal expansion between 14-20×10⁻⁶ in/in/° F.
